(19) United States
(12) Patent Application Publication
(10) Pub. No.: US 2022/0192162 A1
(43) Pub. Date: Jun. 23, 2022

(54) SYSTEMS AND METHODS FOR HANDLING FARMED AQUATIC ANIMALS

(71) Applicant: MMC First Process AS, Fosnavag (NO)

(72) Inventors: Leif Roger GJELSETH, Bolandet (NO); Børre Haanes WAAGAN, Gurskoy (NO); Sivert Audun Reite BLINDHEIM, Skodje (NO)

(21) Appl. No.: 17/149,002

(22) Filed: Jan. 14, 2021

(30) Foreign Application Priority Data
Dec. 22, 2020 (NO) 20201423

(51) Int. Cl. A01K 63/00

(52) U.S. Cl. CPC A01K 63/006

(57) ABSTRACT

A screen for a fluid tank, the screen comprising: at least one expandable screen section configured to be positioned on a fluid tank to permit movement of the at least one expandable screen section relative thereto, wherein the at least one expandable screen section is configurable between an expanded state and a contracted state. There is also provided a tank having a screen arranged vertically movable therein and a method for moving aquatic animals out of a tank, the method comprising: arranging the at least one expandable screen section in or on the tank in the contracted state; bringing the at least one expandable screen section to the expanded state; and moving the screen relative to the tank to crowd the animals towards an outlet in the tank.

### CROSS-REFERENCE TO RELATED APPLICATIONS

This application claims priority and the benefit of Norwegian Patent Application No. 20201423 filed Dec. 22, 2020, the contents of which are hereby incorporated by reference into this application in their entirety.

### FIELD OF INVENTION

The present invention relates to a system and method for handling aquatic animals in a production farm, such as the movement of fish out of a farm tank in a fish farm.

### BACKGROUND

Farming of aquatic animals, such as fish, is a growing industry worldwide and plays a key role for human food supply in many countries. Often, such farming is carried out in tanks, which may be positioned onshore, i.e. in land-based tanks. Land-based farming may be done for the entire production cycle of a particular species, or parts of it, for example for salmon during the first parts of the life cycle before the fish is moved to sea-based pens.

During such farming in tanks, the animals may have to be moved several times. This may be the case for example if a tank needs to be emptied (e.g. for cleaning), if a number of animals need to be split between several tanks, if measurements, counting, treatment or similar steps are needed, or for other reasons.

In such farming, efficient processes are of high importance in order to reduce cost and to reduce the time required, since for example pumping or movement may create increased stress levels for aquatic animals, which can be detrimental to production rates and generally should be avoided as much as possible in order to maintain good animal welfare. Operational efficiency and plant capital cost are also factors of high importance in the design of plants for such farms, in order to best utilize production capacity and provide high return on investment.

There is as such a need for improved solutions for handling of aquatic animals, hereunder moving such animals within a farm. The present invention has the objective to provide such improved solutions, or at least alternatives to known systems and techniques.

### SUMMARY

It is an object of the present disclosure to mitigate, alleviate or eliminate one or more of the above-identified deficiencies and disadvantages in the prior art and solve at least the above mentioned problem.

According to a first aspect there is provided a screen for a fluid tank, the screen comprising: at least one expandable screen section configured to be positioned on a fluid tank to permit movement of the at least one expandable screen section relative thereto, wherein the at least one expandable screen section is configurable between an expanded state and a contracted state.

In another aspect, there is provided a tank having a screen arranged vertically movable therein.

In another aspect, there is provided a method for moving aquatic animals out of a tank, the method comprising: providing a screen; arranging at least one expandable screen section in or on the tank in a contracted state; bringing the at least one expandable screen section to the expanded state; and moving the screen relative to the tank to crowd the animals towards an outlet in the tank.

The detailed description, figures and claims outline further aspects and embodiments.

### BRIEF DESCRIPTION OF THE DRAWINGS

These and other characteristics will become clear from the following description of illustrative embodiments, given as non-restrictive examples, with reference to the attached drawings, in which

FIG. 1 illustrates a tank having a horizontal crowding member installed therein.

FIGS. 2 and 3 illustrate installation of the parts of an expandable screen in the tank, with the parts in a contracted state.

FIG. 4 illustrates the tank having an expandable screen installed in the expanded state.

FIGS. 5, 6, and 7 illustrate a tank having an expandable screen therein positioned towards the base of the tank.

FIG. 8 illustrates further detail of the horizontal crowding member in the tank.

### DETAILED DESCRIPTION

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting.

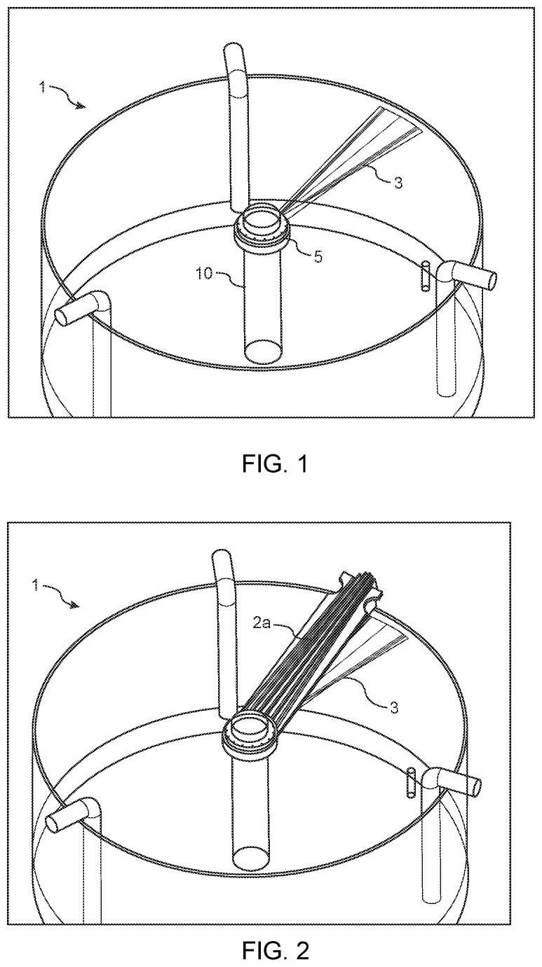

FIG. 1 illustrates a tank 1, which may be, for example, a tank which is part of a land-based aquaculture farm for farming aquatic animals such as fish. The tank 1 may have appropriate water inlets and outlets, such as inlet and outlet pipes, as indicated for filling, emptying or circulating water in the tank. Typically, such a land-based aquaculture farm will have a plurality of similar tanks such as tank 1. Farmed animals may be distributed between tanks according to stages in the production cycle. There will regularly be a need to move animals between tanks, for example for splitting a cohort of animals to reduce density in the tank, for emptying a tank for e.g. cleaning, or for moving the animals e.g. for sale/delivery. In such a process, it is desirable to move the animals out of a tank in a gentle manner, to avoid stress among the animals. It is for example desirable to control the crowding of the animals to avoid over-crowding, and to ensure high water quality (e.g. oxygen levels) during such processes.

In the following examples, embodiments will be described with reference to a fish farm as an example for one such type of aquaculture farm, however it should be understood that the embodiments may be equally well suited for other forms of aquatic animals.

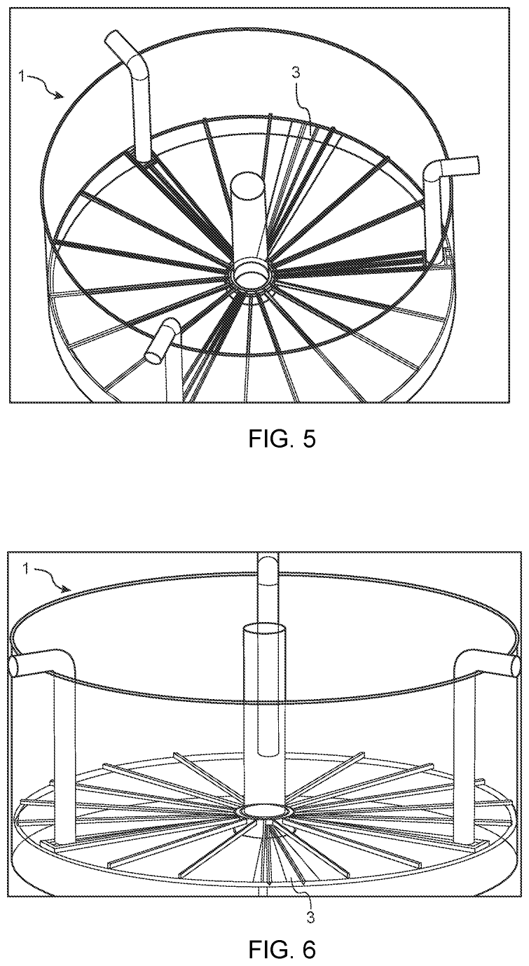

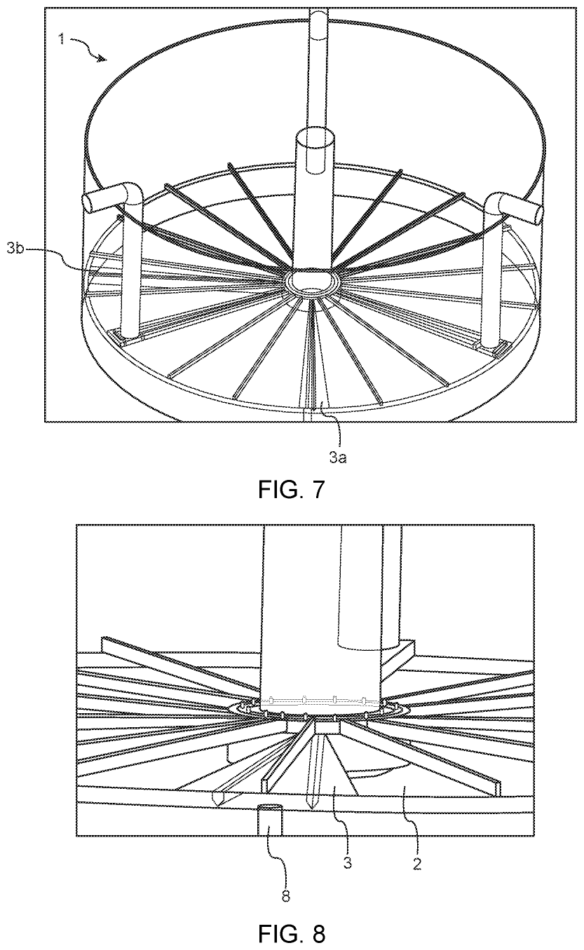

FIGS. 1-8 illustrate various steps in a method according to one embodiment. Through these examples, other aspects of the present disclosure will also become apparent.

The tank 1 may have a central vertical member 10 to which parts 2a-c and a horizontal crowding member 3 (described in further detail below) can be fixed. These parts may be vertically movable along the vertical member 10. For example, a vertically movable attachment member 5 may be arranged with connection points to allow the parts 2a-c and (if applicable) the crowding member 3 to be fixed thereon. Alternatively or additionally the parts 2a-c and (if applicable) the crowding member 3 may be fixed together in the center of the tank 1 when assembling them, for example if the tank 1 does not comprise a central vertical member 10. In some examples, it may be possible to couple the parts 2a-c to the side wall of the tank 1 (e.g. movably or slidably couple), which may provide additional support.

The attachment member 5 may be in the form of a ring or bracket that surrounds the central vertical member 10. The attachment member 5 may be movably attached to the central vertical member 10, and may permit movement of the parts relative to the central member 10 and the tank 1. For example, the attachment member may comprise an arrangement of grippers and/or rollers and/or dynamic seals configured to contact the central vertical member 10, enabling rolling or sliding movement of the attachment member 5 on the central vertical member 10.

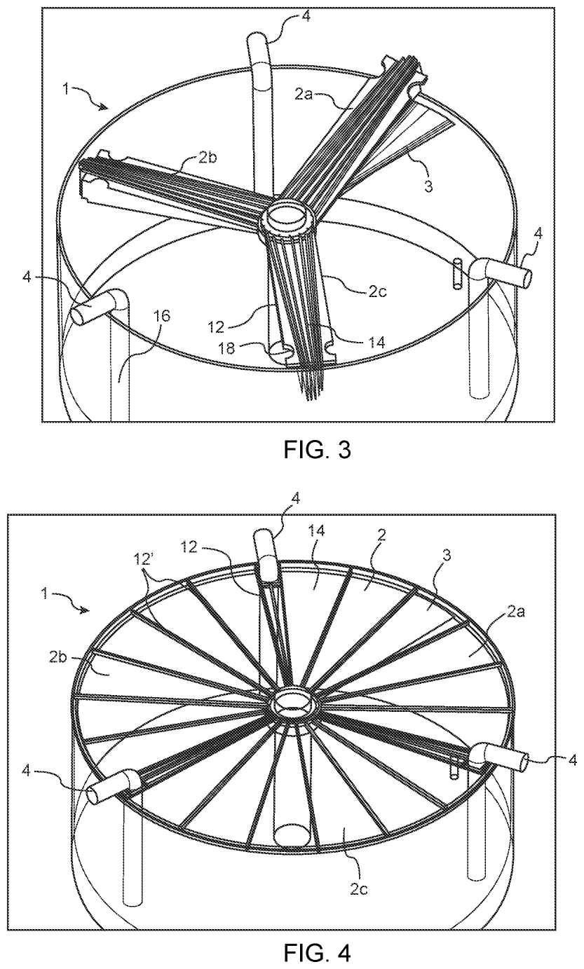

In this example, the tank 1 comprises a plurality of conduits 16 (see FIG. 3) that extend vertically along the wall of the tank 1 and are connected to external piping 4. The conduits may assist to permit an inflow of fluid into the tank 1, and may assist when fluid is required to be added to the tank. In this example, there are three conduits 16, although in other examples there may be more or fewer. In this example, the conduits 16 are evenly circumferentially spaced around the tank 1.

As is visible in FIGS. 1 to 3, each of the parts 2a-c may be separately provided, and may be separately attached to the central member 10 of the tank 1. In this example, there are three parts 2a-c, however it should be noted that in other examples, more or fewer parts may be used. Once the parts 2a-c have been attached to the moveable attachment member 5, the parts 2a-c may be held where they are for a period of time in the contracted state, or the parts 2a-c may be expanded shortly (e.g. immediately) after attachment to the central member 10. As illustrated, the parts 2a-c may be attached at an upper section of the central member 10, for example the upper half of the central member 10, an upper end or extremity of the central member 10, or the like. Attaching the parts 2a-c to this section of the central member 10 may allow the parts to be easily expanded or contracted by a user, who may be most easily able to access the parts when connected to an upper section of the central member 10.

In FIGS. 3 and 4, the parts 2a-c are illustrated in a contracted state (FIG. 3) and in an expanded state (FIG. 4). Each of the parts comprises a coupling arrangement 12 and a screen 14. The coupling arrangement comprises two elongate members, and the screen 14 is comprised therebetween, being attached at opposing ends to the elongate members of the coupling arrangement 12. The elongate members of the coupling arrangement may each comprise a profile, such as a mating profile, enabling the coupling arrangement to couple to a second coupling arrangement, which may be a coupling arrangement of a separate part 2a-c, thereby enabling each of the parts to be coupled together to form the expandable screen. In addition, the elongate members may assist to provide radial support to the expandable screen, once the parts 2a-c are connected together in the expanded configuration. As can be seen in e.g. FIG. 4, there may be further stiffening or support members 12′ arranged between the elongate members of the coupling arrangement 12. These may, for example, comprise beams or rods and be rigid in nature for support and structural stability.

In this example, each of the elongate members of the coupling arrangement 12 comprises a conduit engagement profile 18, to permit the coupling arrangement 12 to engage the conduits 16. As can be seen in FIG. 4, this permits the parts 2a-c to be expanded without interfering with the conduits 16. The conduit engagement profile may comprise a sliding seal and/or rollers to permit a moveable engagement between the engagement profile 18 and the conduit 16. Each of the parts 2a-c is positioned between two of the conduits 16. The number of parts 2a-c may be selected based on the number of conduits 16, to ensure that each of the conduits 16 is able to be engaged by the coupling arrangements 12 of the parts 2a-c, thereby not interfering with the expansion of the parts 2a-c. Although in this example the elongate members comprise an engagement profile 18 for engagement with the conduits 16, as illustrated, the elongate members may comprise a profile for any other objects (e.g. vertically arranged objects) contained within the tank 1, or features on the tank wall, such as protrusions.

The elongate members may be made from a solid material, for example a material that does not change its form in normal use. As such, the elongate members may be easily grippable by a user to facilitate the expansion and contraction of the parts 2a-c. Similarly, any further members 12′ can be made from the same solid material or a material stiffer than the pliable material making up the screen 14, and thereby provide a stiffening effect.

Here, the screen is contained between two elongate members, which together form the coupling arrangement 12. In FIG. 3, the parts 2a-c are in a contracted state, and the screen is folded such that it has a concertina structure (e.g. a structure having a repeated folded arrangement). Having a concertina structure may enable the screen 14 to be easily configured between an expanded and a contracted state, while not compromising the functionality of the screen. In FIG. 4, the elongate members of each coupling arrangement 12 have been moved apart in a circumferential direction, so as to configure each of the parts 2a-c from a contracted configuration to an expanded configuration. While in the contracted configuration, each of the parts 2a-c can have an elongate substantially rectangular shape, the parts 2a-c expand such that in the expanded configuration, each of the parts 2a-c forms the shape of a portion of a circle or toroidal shape. In this example, each of the parts 2a-c are identical in shape and construction, although it should be noted that examples where the parts 2a-c have differing shapes and/or constructions may also be possible. Each of the three parts 2a-c of this example expand to cover a portion of the axial cross-sectional surface (i.e. the cross-sectional surface that lies perpendicular to the axis of the cylindrical tank 1), and are able to be coupled together to form the entire expandable screen. If each of the parts is identical in shape and construction, each covers a third of the cross-sectional surface, which is equal to a circumferential coverage of 120 degrees in this example. In other examples, such as where there are more or fewer parts, then the parts may cover a lesser or greater portion of the axial cross-sectional surface of the tank 1.

It should be noted that, although in this example, the tank 1 is in the shape of a cylinder, other shapes of tank may be possible, such as a cube or extruded rectangle. In such cases, the parts 2a-c may be extendable along the width or length of the axial cross-sectional surface of the tank, rather than circumferentially extending as in the illustrated example. For example, the tank 1 may have a polygonal cross-section shape, such as a hexagonal or octagonal shape. In such a case, the coupling arrangement 12 and/or support members 12′ may be arranged so that the screen 2 has a corresponding polygonal shape when in the expanded state. For example, the screen 2 can be arranged so that the elongate members of the coupling arrangement 12 extend to the vertices (“corners”) of the polygon. In such a case, in order to use a circumferentially expanding solution such as that illustrated in FIGS. 1-8, the parts 2a-c may be assembled partly or fully above the upper edges of the tank 1 (for example, with their outward ends higher than the attachment member 5, i.e. “angled upwards”) so as to allow the parts 2a-c to be brought to their expanded state without interference with the tank walls before the screen 2 is lowered into the tank 1.

The screen 14 may be made from a water permeable material, for example a permeable sheet, mesh, fabric or net. To ensure the water permeability thereof, the screen 14 may comprise an array of apertures therein, sized to permit a flow of fluid (e.g. water) therethrough, but small enough to prevent passage of an aquatic animal such as a fish or shellfish therethrough. As such, once the tank 1 is filled with water and aquatic animals, the screen may be moved therein to prevent passage of an aquatic animal to one part of the tank 1, while permitting the passage of water thereto. In order to assist in configuring the parts between the expanded and contracted configuration, the screen 14 may be made from a flexible material.

Additionally illustrated in the figures is a horizontal crowding member 3. In this example, the horizontal crowding member 3 is attached to the central member 10, at a location below the attachment of the parts 2a-c. The horizontal crowding member 3 may be attached to the central member 10 via the same attachment member 5 as attaches the parts 2a-c to the central member 10, or may be attached to the central member 10 by a separate attachment member 5. As is the case with the parts 2a-c, the horizontal crowding member 3 is moveably attached to the central member 10, such that vertical movement of the horizontal crowding member 3 within the tank 1 and relative to the tank 1 and the central member 10 is possible. Optionally the crowding member 3 may be installed directly onto or permanently arranged at a bottom of the tank 1 and not be vertically movable.

In contrast to the parts 2a-c, the horizontal crowding member 3 may not be configurable between an expanded and contracted state, but may simply have one state in which it remains throughout use. As will be described in relation to the use of the expandable screen, the horizontal crowding member 3 may be used to crowd aquatic animals in the tank 1 by moving in a circumferential direction in the tank in the Figures, or in the direction of the length and/or width of the tank 1 in cases where the tank has a cubic or cuboidal shape, for example. As such, the horizontal crowding member 3 may be able to be moved both vertically relative to the tank 1, as well as circumferentially, in particular relative to the central member 10. The horizontal member 3 may be able to move circumferentially relative to the attachment member 5 (e.g. on a bearing in the attachment member).

Operation of the expandable screen (illustrated as 2a-c in the Figures) is illustrated in FIGS. 3 to 8, which show the parts 2a-c having been attached to the central member 10, and the expandable screen ready for use. FIG. 4 illustrates the expandable screen in the expanded state located at a top end of the tank 1, which may be considered to be the starting position of the expandable screen during operation thereof. In this example, the starting position of the expandable screen may be anywhere in the tank 1 that is above, or at the level of, the fluid level in the tank 1.

Once the expandable screen has been configured to the expanded state, the expandable screen may then be moved in a vertical direction relative to the tank 1, towards the base of the tank 1. As the screen 14 is permeable to fluid, in this instance freshwater or seawater, the fluid will pass through the screen. However, aquatic animals that are located below the expandable screen will remain below the expandable screen and be crowded against the screen and the base of the tank 1. The expandable screen may continue to be moved in a downward vertical direction within the tank 1 until the expandable screen is at the position as shown in FIG. 6, at which point no further movement may be desirable or possible without harming the aquatic animals that are located below the screen.

The expandable screen, which functions as a crowding member here, may be suspended form ropes, wires or cables, which may be attached thereto during assembly (e.g. attached to the elongate members of the expandable screen), and which are omitted from the Figures for clarity. It should be noted that the expandable screen may be held in place by other means, for example via the attachment member and optionally via engagement with the wall of the tank 1, for example by a roller engagement, brush engagement, or any other appropriate engagement means that permits relative motion thereof.

Vertical movement of the expandable screen may be effected by hoisting of the cables on which the expandable screen is held, for example by means of a winch mechanism. Alternatively, the expandable screen may move under gravity, its movement being controlled by resistance provided by wires, cables, ropes etc. to which it is attached. In this case, the wires, cables, ropes etc. may be held in a spool comprising a braking arrangement. As such, the braking arrangement may prevent movement of the expandable screen under gravity, and may be released once downward movement of the expandable screen is desired.

The buoyancy of the expandable screen may be neutral, or slightly less buoyant than the fluid in the tank, which may facilitate vertical movement of the expandable screen through the fluid.

With the aquatic animals crowded below the expandable screen, it may be desirable to remove the aquatic animals from the tank, which may have been the purpose of crowding the animals towards the base of the tank 1. As such there may be an outlet 8 (see FIG. 8) positioned in the base of the tank 1, or in the wall of the tank 1 adjacent the base, that is able to be selectively opened to permit aquatic animals to pass from the tank and into a separate vessel, for example a further tank or a transport vessel. The outlet may be selectively openable by a user, and may be opened once the aquatic animals have been crowded in the tank 1.

Once the aquatic animals are crowded towards the base of the tank 1, there may a need to move the aquatic animals towards the opening, which may be achieved through use of the horizontal crowding member 3. The horizontal crowding member 3 may be in the form of an elongate member, or series of elongate members, that extend from the attachment member 5 or the central member 10 in a radial direction, or lateral direction relative to the central member 10. The height of the horizontal crowding member 3 may be equal to the distance between the expandable screen and the base of the tank, when the expandable screen is at its lowest point in the tank. As such, the horizontal crowding member 3 may be able to be moved around the central member 10, e.g. in a circumferential direction, to move the aquatic animals in a sweeping motion towards an outlet in the tank 1, thereby encouraging the animals to exit the tank 1 via the outlet.

The horizontal crowding member 3 may additionally comprise a stationary element 3a, in addition to a moveable element 3b that moves around the central member 10 e.g. in a circumferential direction, as described above. The stationary element 3a may be attached to the attachment member 5 or the central member 10, and may be able to be moved vertically relative to the tank, with the horizontal crowding member 3. However, the stationary element 3a may not be moved around the central member 10 in a circumferential direction. Instead, the stationary element 3a may be positioned adjacent the outlet in the tank 1, and may function to move aquatic animals through the outlet in the tank 1 as the moveable element 3b is swept in a circumferential direction, for example. As such, in operation the moveable element 3b may crowd the animals towards the stationary element 3a, where the animals may then be induced to move through the outlet in the tank 1.

In all the embodiments described herein, the horizontal crowding member 3 may be a part which is removably installable in the tank 1, as for the parts 2a-c and together with these, or permanently installed in the tank 1.

The use of a horizontal crowding member 3 may, however, not be necessary if removal of all or the desired number of animals from the tank 1 can be achieved by means of the screen 2 only, for example if only a part of the animals is to be removed or if all animals can be removed by induced water flow towards the outlet 8 or by other means.

In another example, the above principles can be applied equivalently to crowd the animals towards to a top part of the tank 1. In such a case, the parts 2a-c can be mounted at a bottom part of the tank 1 in the contracted state, then expanded and the crowding operation can be carried out by moving the screen 2 upwardly in the tank 1. In such a case, an outlet for animals at the top part of the tank 1 can be open for removing animals from the tank during the crowding operation. A horizontal crowding member 3 may optionally be used also in such a case, but then vertically above the screen 2.

The screen 2 may, optionally, be made up of only one expandable part or section. For example, if part 2a in FIG. 2 is arranged so as to be expandable to cover the entire cross-sectional area of the tank 1 (i.e., substantially being expandable 360 degrees), then the second and third parts 2b,c may not be necessary. Optionally, the screen 2 may be made up of two parts or sections extending diametrically across the tank 1. Using more than three parts or sections is also possible.

One or more of the parts or sections 2a-c may be connected together before installing them on or in the tank 1. For example, if two sections are used extending diametrically across the tank 1, these may be connected together before arrangement in the tank, for example in order that only one lifting or installation operation be required.

In one embodiment, the screen 2 may comprise a sorting grid, having openings with a pre-defined size to permit animals of a certain size to pass through the grid but to retain animals which are larger than a pre-set threshold. The sorting grid may comprise a plurality of parallel rods, as is common in the industry. For example, one of the parts 2a-c in the example of FIGS. 1-8 may be replaced by a corresponding part having a sorting grid arranged therein. The part having the sorting grid may be expandable or not expandable. Typically, the sorting grid may be a rigid or semi-rigid structure, such as a plastic or metal structure, which for example may be integrated into a screen section which otherwise is made up as the parts 2a-c described above.

By providing a screen 2 having one part comprising a sorting grid, considerable flexibility can be provided for sorting and handling animals. For example, a fish farm may hold several such parts, with sorting grids of different size settings. If a cohort of fish is to be sorted, a screen 2 can be built using the sorting grid of desired size setting, and the fish in the tank 1 can be crowded as described above, however in this case fish of a smaller size than the sorting grid setting will be able to pass through the screen 2 and therefore be retained in the tank 1. Fish which are larger than the sorting grid size setting will be crowded towards the outlet 8 and can be moved from the tank 1, as described above.

Advantageously, by providing systems and methods as described above, an expandable screen (which may be considered to be a crowding screen) can be more easily deployed and (if required) removed from a tank 1 by avoiding the need to lift and move a large structure. Further, the embodiments may allow a single screen to be used in different tanks by more easily allow moving of the screen to another tank. This avoids the need to move a large structure or to have permanent crowding screens installed in each such tank in a multi-tank fish farming plant, thereby reducing labor and/or cost.

The invention is not limited by the embodiments described above; reference should be had to the appended claims.

1. A screen for a fluid tank, the screen comprising:
at least one expandable screen section configured to be positioned on a fluid tank to permit movement of the at least one expandable screen section relative thereto,
wherein the at least one expandable screen section is configurable between an expanded state and a contracted state,
and wherein each screen section comprises a plurality of rigid elongate members' having a pliable, water-permeable material arranged therebetween.

2. A screen according to claim 1, wherein the screen in the expanded state is circular and the elongate members are arranged radially.

3. A screen according to claim 1, wherein the screen in the expanded state is arranged to cover an entire axial cross-sectional area of the tank.

4. A screen according to claim 1, wherein the screen is configurable to move vertically within the tank.

5. A screen according to claim 4, wherein the screen is:
configured to be mounted at an upper part of the tank and moved vertically downwards in the tank, or
configured to be mounted at a lower part of the tank and moved vertically upwards in the tank.

6. A screen according to claim 1, comprising at least two expandable screen sections, and wherein in the expanded state the at least two expandable screen sections is coupleable to a one other of the at least two expandable screen sections to form the screen.

7. A screen according to claim 6, wherein each of the at least two expandable screen sections comprises a coupling arrangement for coupling each of the at least two expandable screen sections to a wall of the fluid tank.

8. A screen according to claim 6, wherein in the expanded state, the at least two expandable screen sections form a circular screen.

9. A screen according to claim 6, wherein the at least two expandable screen sections are expandable from the contracted state to the expanded state in a circumferential direction.

10. A screen according to claim 6, wherein each of the at least two expandable screen sections comprises a material having a concertina structure.

11. A screen according to claim 6, wherein each of the at least two expandable screen sections comprises a coupling profile for coupling each of the at least two expandable screen sections to the one other of the at least two expandable screen sections.

12. A screen according to claim 6, comprising three expandable screen sections.

13. A screen according to claim 1 comprising a screen section having a sorting grid.

14. A tank having a screen according to claim 1 arranged vertically movable therein.

15. A tank according to claim 14, comprising a central column to which the at least one expandable screen section is movably coupled to permit vertical movement of the screen relative to the tank.

16. A tank according to claim 14, comprising a horizontal crowding member.

17. A tank according to claim 14, wherein the tank has
a cylindrical horizontal cross-section, or
a polygonal horizontal cross-section, and
the screen covers the entire cross-sectional area of the tank.

18. A method for moving aquatic animals out of a tank, the method comprising:
providing a screen comprising:
at least one expandable screen section configured to be positioned on a fluid tank to permit movement of the at least one expandable screen section relative thereto,
wherein the at least one expandable screen section is configurable between an expanded state and a contracted state,
and wherein each screen section comprises a plurality of rigid elongate members' having a pliable, water-permeable material arranged therebetween;
arranging the at least one expandable screen section in or on the tank in the contracted state;
bringing the at least one expandable screen section to the expanded state; and
moving the screen relative to the tank to crowd the animals towards an outlet in the tank.

19. A method according to claim 18, the method comprising
arranging a horizontal crowding member in or on the tank, and
moving the horizontal crowding member to crowd the animals towards the outlet.

20. A method according to claim 18, the method comprising:
moving the screen from an upper part of the tank to a lower part of the tank to crowd the animals in the lower part of the tank, or
moving the screen from a lower part of the tank to an upper part of the tank to crowd the animals in the upper part of the tank.
